(19) United States
(12) Patent Application Publication
(10) Pub. No.: US 2009/0263104 A1
(43) Pub. Date: Oct. 22, 2009

(54) STREAM PLAYBACK CONTROL DEVICE

(76) Inventor: Koichi Tsutsumi, Osaka (JP)

Correspondence Address: MCDERMOTT WILL & EMERY LLP, 600 13TH STREET, NW, WASHINGTON, DC, 20005-3096, US

(21) Appl. No.: 12/064,984

(22) PCT Filed: Jul. 28, 2006
(86) PCT No.: PCT/JP2006/315031

§ 371 Date: Feb. 27, 2008

(30) Foreign Application Priority Data
Oct. 7, 2005 (JP) 2005-295314

(51) Int. Cl. H04N 5/91

(52) U.S. Cl. 386/95; 386/E05.003

(57) ABSTRACT

Time information for restoring the playback rate is affixed to a plurality of packets included in a stream. A predetermined number of such packets are stored in advance in a buffer memory 9. A packet arrival time detection section 5 detects the input time of a reference-time packet (packet having arrived first at the start of stream playback). A time correction section 7 loads the input time of the reference-time packet into a time counter ≢after a lapse of a predetermined time. A comparison section 8 compares the time information of each packet stored in the buffer memory 9 with the time measured from the loaded input time in the time counter 6 and, if the two values agree, outputs the packet in question to a packet processing section 12. Thus, even under circumstances causing fluctuations in the transfer time of a stream from the recording medium and the like, underflow in rate reproduction of the stream is less prone to occur.

### TECHNICAL FIELD

The present invention relates to a playback control device for a stream composed of a plurality of packets each having time information for restoring the playback rate, and more particularly, to a device for controlling playback of a transport stream (TS) with time information (time stamps) defined by the International Standards Organization (ISO) affixed thereto.

### BACKGROUND ART

Nowadays, in digital broadcasting, data is transmitted using a packet multiplexing format called a transport stream format. A digital broadcast recording/playback apparatus records data on a recording medium in a time information-affixed transport packet format in which time information (a time stamp) indicating the packet arrival time is affixed to each packet, during recording. During playback, the packet interval is restored based on the time information, to thereby reproduce the rate of the recorded stream. Such a time information-affixed transport packet has a configuration as shown in FIG. 4. A stream playback control device for such an AV playback apparatus is disclosed in Patent Document 1, for example.

In the conventional stream playback control device, packets are sequentially read from a recording medium and inputted into the stream playback control device directly or after being buffered via an external memory. At the time of arrival of the first packet at the stream playback control device, time information affixed to the first packet is loaded into a time counter that counts up at 27 MHz. As for the subsequent packets, time information affixed to each of the packets is compared with the count value of the time counter. Once the two values agree, the packet in question is outputted to a downstream packet processing section. In this way, the rate of the stream is reproduced. Patent Literature 1: Japanese Laid-Open Patent Publication No. 2004-336332

### DISCLOSURE OF THE INVENTION

### Problems To Be Solved By The Invention

In recent years, various applications including simultaneous viewing/distribution of a plurality of streams and the like have been made available to the users. Access to a recording medium and an external memory therefore tends to be very busy, and with this, fluctuations in the data transfer time of a stream inputted from the recording medium and the external memory into the stream playback control device have become great. With fluctuations in data transfer time becoming great, there arises a problem that when a packet arrives at the stream playback control device, the time indicated by the time counter has already passed the time indicated by the time information of the packet that has arrived and this may easily cause underflow in rate reproduction.

In particular, in simultaneous playback of a plurality of different streams, fluctuations in the data transfer time of each stream eminently increase. In some stream, therefore, underflow in rate reproduction may easily occur.

An object of the present invention is implementing a stream playback control device capable of making underflow in rate reproduction less prone to occur during playback of a single stream or a plurality of streams from a recording medium or an external memory.

### Means for Solving the Problem

To attain the above object, according to the present invention, a predetermined number of packets included in a stream from a recording medium or an external memory are temporarily stored in a buffer, and then the rate of the stream is reproduced based on time information affixed to these packets.

The stream playback control device of the present invention is a stream playback control device for reproducing the rate of a stream including a plurality of packets having time information for restoring a playback rate affixed thereto, including: a stream input control section for controlling input of a stream into the stream playback control device; a buffer memory for temporarily holding a plurality of packets having time information inputted into the stream playback control device; a time counter for counting up in a specific time cycle; a time correction section for loading time information of a packet inputted at a predetermined reference time point into the time counter after a lapse of a predetermined time from the timing of input of the packet; and a comparison section for comparing a count value of the time counter with time information of each packet held in the buffer memory, wherein the rate of the stream is reproduced by restoring each packet interval of the stream based on the comparison results of the comparison section.

In the stream playback control device described above, in the time correction section, the predetermined time from the input of the packet having the predetermined reference time until the loading of the time information of the packet having the predetermined reference time into the time counter may be determined depending on the data amount of the stream held in the buffer memory.

In the stream playback control device described above, the buffer memory may also be used as a packet data processing buffer for executing parsing and the like of a plurality of stored packets.

In the stream playback control device described above, the comparison section may compare the count value of the time counter with time information of each packet held in the buffer memory and, if the two values agree, output a packet interval reproduction timing signal, and the stream playback control device may include a packet playback interval monitoring section for monitoring the time interval of the packet interval reproduction timing signal from the comparison section.

In the stream playback control device described above, if the output time interval of the monitored packet interval reproduction timing signal exceeds a preset time interval, the packet playback interval monitoring section may permits: downstream packet processing to start without waiting for the packet interval reproduction timing signal from the comparison section; and the time correction section to correct the time of the time counter using a packet next inputted into the stream playback control device as a packet having a reference time.

Alternatively, the stream playback control device of the present invention is a stream playback control device for reproducing the rate of a stream including a plurality of packets having time information for restoring a playback rate affixed thereto, including: a stream input control section for controlling input of a plurality of different streams into the stream playback control device under packet-unit time division multiplexing transmission; a buffer memory for temporarily holding a plurality of packets having time information inputted into the stream playback control device, stream identification information being affixed to each of the plurality of packets; a time counter provided for each of the plurality of streams for counting up in a specific time cycle; a time correction section provided for each of the plurality of streams for loading time information of a packet having a predetermined reference time after a lapse of a predetermined time from input of the packet having the predetermined reference time; and a comparison section provided for each of the plurality of streams for comparing a count value of the time counter with time information of each packet held in the buffer memory, wherein the rate of each of the streams is reproduced by restoring the packet interval of the stream based on the comparison results of each of the comparison sections.

In the stream playback control device described above, the stream input control section may control arbitration of input among the plurality of streams according to the number of packets of each of the streams stored in the buffer memory.

In the stream playback control device described above, the arbitration control performed by the stream input control section may be counting the number of remaining packets held in the buffer memory for each stream after input of the packet having the predetermined reference time and putting priority on input of a stream for which the counted number of remaining packets is below a predetermined threshold.

In the stream playback control device of described above, the time correction section may convert time information Ti affixed to an i-th packet (i is an arbitrary natural number) to time information T′i based on the time information Ti and time information Ti-1 affixed to an (i-1)th packet by calculating an equation:

T′i=T′i-1+(Ti-Ti-1)* α(α<1).

In the stream playback control device described above, the comparison section may compare the count value of the time counter with time information of each packet held in the buffer memory and, if the two values agree, output a packet interval reproduction timing signal, and the stream playback control device may include a packet multiplex output section for multiplexing packets of the plurality of streams based on the packet interval reproduction timing signal outputted from the comparison section and outputting the multiplexed results.

As described above, according to the present invention, a predetermined number of packets received from a recording medium and an external memory are stored in advance in the buffer memory. The packet arrival time detection section detects the input time of a reference-time packet (packet having arrived first at the start of stream playback). The time correction section loads the input time of the reference-time packet into the time counter after a lapse of a predetermined time. The comparison section compares time information of each packet stored in the buffer memory with the time measured from the loaded input time in the time counter and, if the two values agree, outputs the packet in question to the packet processing section. Thus, since fluctuations in stream data input can be absorbed with the buffer memory, underflow in rate reproduction can be made less prone to occur.

In particular, according to the present invention, since the time counter, the time correction section and the comparison section are provided for each stream, fluctuations in data input can be absorbed for each stream, and thus underflow in rate reproduction can be made less prone to occur. Moreover, according to the present invention, the stream input control section performs arbitration control so that priority is put on a stream for which the number of remaining packets stored in the buffer memory is below a predetermined threshold. In the case of inputting a plurality of streams, therefore, underflow in rate reproduction can be made less prone to occur for all the streams.

### EFFECT OF THE INVENTION

As described above, the stream playback control device of the present invention can absorb fluctuations in the transfer time of data from a recording medium or an external memory and thus make underflow in rate reproduction less prone to occur.

In particular, according to the present invention, in simultaneous playback of a plurality of different streams, underflow in rate reproduction can be made less prone to occur for all the streams.

### BRIEF DESCRIPTION OF THE DRAWINGS

FIG. 1 is a block diagram of a stream playback control device of Embodiment 1 of the present invention.

FIG. 2 is a timing chart showing packet interval reproduction operation.

FIG. 3 is a block diagram of a stream playback control device of Embodiment 2 of the present invention.

FIG. 4 is a view illustrating a configuration of a time information-affixed transport packet.

### DESCRIPTION OF REFERENCE NUMERALS

1 Recording medium

2 External memory

3 Stream input control section

4, 4a to 4c Rate reproduction part

5 Packet arrival time detection section

6 Time counter

7 Time correction section

8 Comparison section

9 Buffer memory

10 Stream playback control device

11 Packet playback interval monitoring section

12 Packet processing section

13 Packet output section (Packet multiplex output section)

14 Delay section

### BEST MODE FOR CARRYING OUT THE INVENTION

Hereinafter, embodiments of the present invention will be described with reference to the relevant drawings.

### Embodiment 1

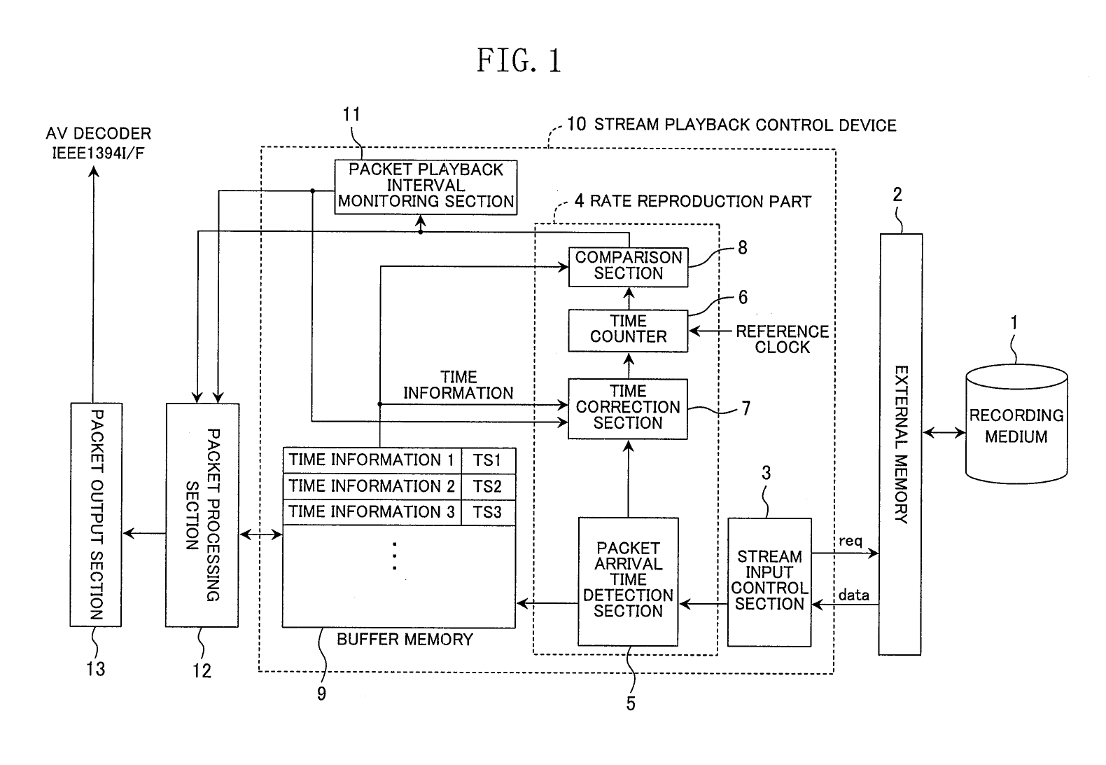

FIG. 1 is a block diagram of a stream playback control device of Embodiment 1 of the present invention

Referring to FIG. 1, a stream playback control device 10 includes a stream input control section 3, a rate reproduction part 4, a buffer memory 9 and a packet playback interval monitoring section 11. The rate reproduction part 4 incorporates therein a packet arrival time detection section 5, a time counter 6, a time correction section 7 and a comparison section 8.

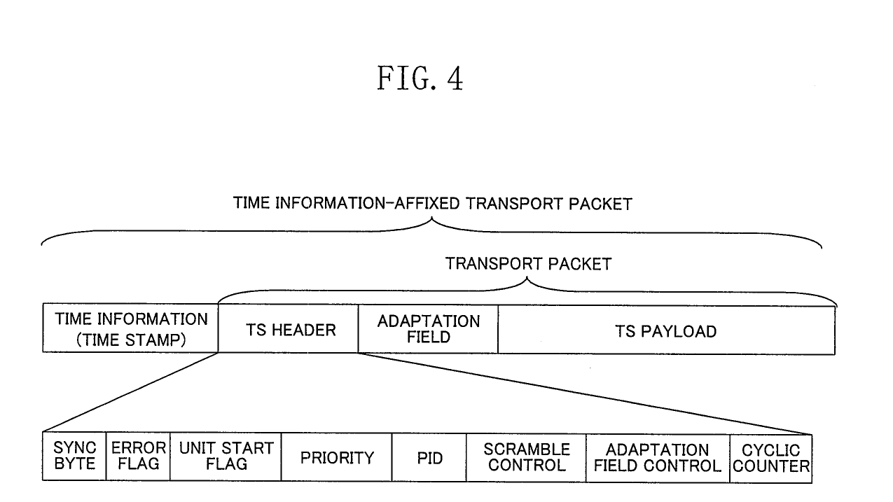

First, a stream recorded in the format shown in FIG. 4 is read from a recording medium 1 to an external memory 2. The stream input control section 3 controls packet-unit input of a stream into the stream playback control device 10 according to the stream accumulated amount in the external memory 2 and the stream accumulated amount (number of packets) held in the buffer memory 9. The inputted packets are stored in the buffer memory 9.

The packet arrival time detection section 5 detects the input timing of a reference-time packet (packet having arrived first at the start of stream playback) and the input timing of each of the subsequent packets. Once the input timing of the reference-time packet has been detected by the packet arrival time detection section 5, the time correction section 7 loads the time information of the reference-time packet into the time counter 6 after a time interval from the detection until the data accumulated amount in the buffer memory 9 has reached a predetermined amount or after a lapse of a predetermined time. In this way, reproduction of the packet interval is prepared only after a desired data amount has been accumulated in the buffer memory 9.

The time counter 6 is a counter counting up in a reference clock cycle. The comparison section 8 compares the count value of the time counter 6 with the time information of each packet and, if the two values agree, outputs a packet interval reproduction timing signal to a packet processing section 12.

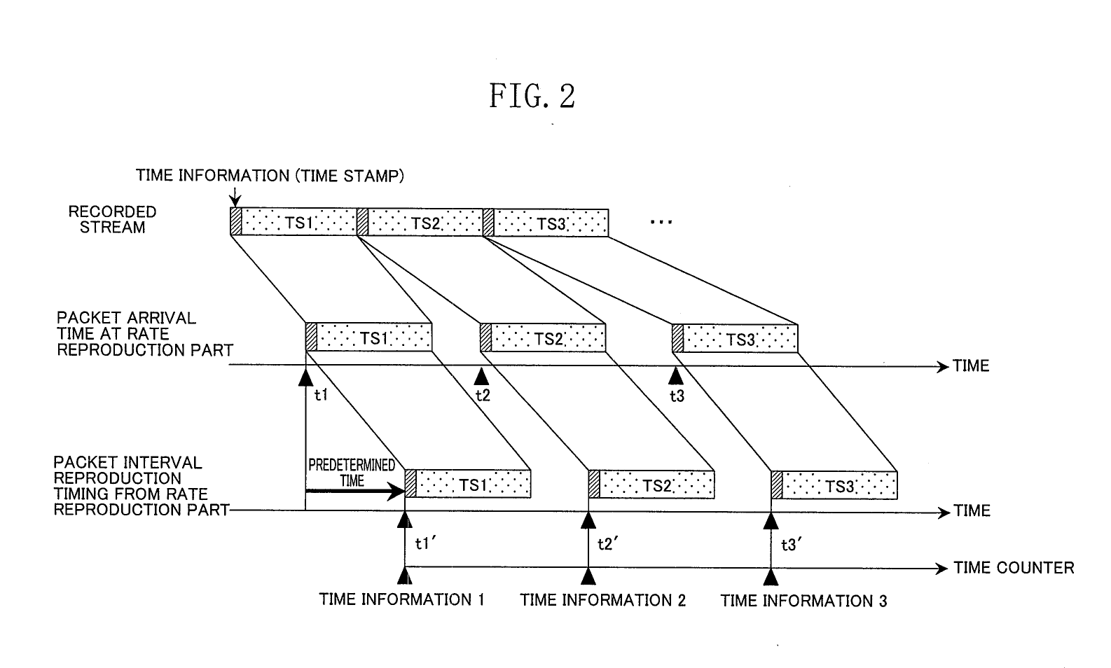

The process described so far will be discussed in more detail with reference to FIG. 2.

FIG. 2 is a timing chart showing reproduction of the rate of a stream recorded in the recording medium 1 performed in the rate reproduction part 4.

Referring to FIG. 2, in which the arrival times of packets at the rate reproduction part 4, detected by the packet arrival time detection section 5, are denoted by t1, t2, t3, . . . , and the packet interval reproduced times are denoted by t1′, t2′, t3′ . . . , the time correction section 7 loads time information 1 of the reference-time packet (first packet) into the time counter 6 at the time t1′ after a lapse of a predetermined time from the arrival time t1 of the reference-time packet. Thereafter, the packet interval reproduced time t2′, for example, will be the time at which time information 2 agrees with the measured time of the time counter 6.

Meanwhile, the packet processing section 12 performs, after a plurality of packets have been stored in the buffer memory 9, packet parsing and the like that can be executed even before the packet interval reproduction, such as PID filtering. In the illustrated example, the buffer memory 9 is used as a packet processing buffer for executing parsing and the like of stored packets. This improves the use efficiency of the buffer memory 9 and can reduce the circuit area.

The packet processing section 12 then performs extraction of PCR (program clock reference) and timing control of packet output to a packet output section 13 by receiving the packet interval reproduction timing signal. The packet output section 13 controls packet output to an AV decoder, an IEEE 1394 I/F and the like.

The packet playback interval monitoring section 11 monitors the time interval of the packet interval reproduction timing signal outputted from the comparison section 8 and, if detecting that the time interval exceeds a preset time interval, instructs the packet processing section 12 to perform processing of a packet stored in the buffer memory 9 without waiting for the packet interval reproduction timing signal from the comparison section 8, and also instructs the time correction section 7 to correct again the value of the time counter 6 with time information of a packet next arriving at the stream control device 10.

As described above, in the stream playback control device of this embodiment, the rate reproduction processing is started after a desired data amount has been accumulated in the buffer memory 9. Therefore, even though the data transfer time from the external memory 2 to the stream playback control device 10 is fluctuated, it is possible to absorb such fluctuations and make underflow in rate reproduction less prone to occur.

In addition, since the buffer memory 9 is also utilized as a buffer for processing in the packet processing section 12, the use efficiency of the buffer memory 9 can be improved. Moreover, the packet interval reproduction timing signal is monitored, and if the time interval of the signal is greater than a predetermined time interval, the time counter 6 is corrected. This permits continuous rate reproduction control, and thus underflow in rate reproduction can be further suppressed.

### Embodiment 2

Next, a stream playback control device of Embodiment 2 of the present invention will be described.

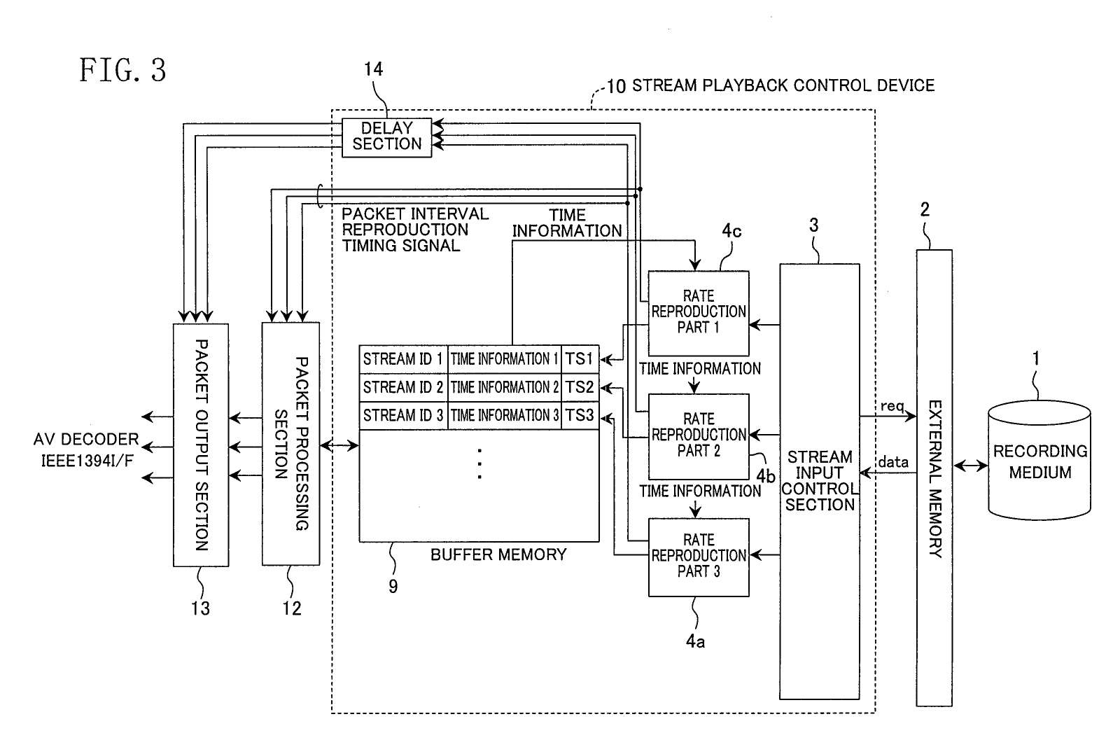

FIG. 3 shows an exemplary configuration of a stream playback control device of this embodiment. Note that three rate reproduction parts 4a to 4c shown in FIG. 3 are the same in configuration as the rate reproduction part 4 shown in FIG. 1, each of which therefore includes the packet arrival time detection section 5, the time counter 6, the time correction section 7 and the comparison section 8. Note also that this embodiment exemplifies a configuration applied when three different streams are simultaneously played back, where the rate reproduction parts 4a to 4c are provided for the respective streams.

First, the stream input control section 3 selects a stream that should be assigned higher priority in inputting from the external memory 2 by an arbitration method in which the number of packets, among the packets held in the buffer memory 9, for which the packet interval reproduction timing signal has not been issued from any of the rate reproduction parts 4a to 4c (number of remaining packets) is counted for each stream and higher priority is put on input of a stream for which the number of remaining packets is below a predetermined threshold. The stream input control section 3 then performs stream input control under packet-unit time division multiplexing transmission. At the start of stream playback, however, the number of packets held in the buffer memory 9 is inevitably below the threshold. Therefore, until the time when the time correction section 7 loads the time information of the reference-time packet into the time counter 6, no priority is put on the input of the stream, but the stream input control is performed under predetermined rules.

The buffer memory 9 holds packets together with respective stream identifiers for identifying the streams. The packet processing section 12 identifies a stream with the stream identifier affixed to each packet and handles the packet under predetermined rules made for each stream.

A delay section 14 delays the packet interval reproduction timing signals outputted from the rate reproduction parts 4a to 4c by a predetermined time. The packet output section (packet multiplex output section) 13 controls the start of output of packets based on the packet interval reproduction timing signals delayed by the delay section 14 and multiplexes packets in order of occurrence of the timing, to thereby multiplex a plurality of different streams and output the multiplexed results.

In special playback such as fast forward, the rate reproduction parts 4a to 4c convert normal time information Ti affixed to an i-th packet (i is an arbitrary natural number) to shortened time information Ti-1(Ti?) based on the time information Ti and time information Ti-1 affixed to an (i-1)th packet by calculating the following equation.

T′i=T′i-1+(Ti-Ti-1)* α(αis a predetermined constant)

Using the converted time information T′i, the packet interval is reproduced. The constant α is set as α=1 during normal playback and as α<1 during special playback such as fast forward. With this, stream playback control at a fixed multiple speed can be easily attained. Conventionally, in special playback such as multiple-speed playback, stream playback control is performed in response to a data request from a downstream AV decoder, not referring to time information of each packet. Therefore, the data transfer adjustment control depends on a demand from the downstream A/V decoder that is irrelevant to the stream input control of the stream playback control device, and as a result, there arises a problem that the control of input of a stream from the recording medium 1 or the external memory 2 into the stream playback control device 10 becomes difficult and complicated. In this embodiment, however, stream playback control at a fixed multiple speed can be attained easily as described above.

As described above, the stream playback control device of this embodiment adopts the arbitration method in which the number of remaining packets held in the buffer memory 9 waiting for the packet interval reproduction timing signal is counted for each stream and stream input control is performed based on the number of packets. It is therefore possible to attain stream input control that makes underflow in rate reproduction less prone to occur.

Also, packets are multiplexed in order of occurrence of packet interval reproduction timing for the packets of a plurality of streams, to thereby attain multiplexing of the plurality of streams. The multiplexed streams are outputted to an AV decoder. It is therefore possible to attain simultaneous viewing of a plurality of different AV contents.

Moreover, during special playback such as fast forward, a packet interval T′i shorter than the packet interval during normal playback is calculated based on successive time information Ti and Ti-1, to perform rate reproduction. It is therefore possible to easily attain stream playback at a fixed multiple speed faster than during normal playback.

### INDUSTRIAL APPLICABILITY

As described above, according to the present invention, fluctuations in the data transfer time of a stream from a recording medium or an external memory, if any, can be absorbed, making underflow in stream rate reproduction less prone to occur. The present invention is therefore useful as a stream playback control device for digital broadcasting and the like.

1. A stream playback control device for reproducing the rate of a stream including a plurality of packets having time information for restoring a playback rate affixed thereto, comprising:
a stream input control section for controlling input of a stream into the stream playback control device;
a buffer memory for temporarily holding a plurality of packets having time information inputted into the stream playback control device;
a time counter for counting up in a specific time cycle;
a time correction section for loading time information of a packet inputted at a predetermined reference time point into the time counter after a lapse of a predetermined time from the timing of input of the packet; and
a comparison section for comparing a count value of the time counter with time information of each packet held in the buffer memory,
wherein the rate of the stream is reproduced by restoring each packet interval of the stream based on the comparison results of the comparison section.

2. The stream playback control device of claim 1, wherein in the time correction section, the predetermined time from the input of the packet having the predetermined reference time until the loading of the time information of the packet having the predetermined reference time into the time counter is determined depending on the data amount of the stream held in the buffer memory.

3. The stream playback control device of claim 1, wherein the buffer memory is also used as a packet data processing buffer for executing parsing and the like of a plurality of stored packets.

4. The stream playback control device of claim 1, wherein the comparison section compares the count value of the time counter with time information of each packet held in the buffer memory and, if the two values agree, outputs a packet interval reproduction timing signal, and
the stream playback control device comprises a packet playback interval monitoring section for monitoring the time interval of the packet interval reproduction timing signal from the comparison section.

5. The stream playback control device of claim 4, wherein, if the output time interval of the monitored packet interval reproduction timing signal exceeds a preset time interval, the packet playback interval monitoring section permits:
downstream packet processing to start without waiting for the packet interval reproduction timing signal from the comparison section; and
the time correction section to correct the time of the time counter using a packet next inputted into the stream playback control device as a packet having a reference time.

6. A stream playback control device for reproducing the rate of a stream including a plurality of packets having time information for restoring a playback rate affixed thereto, comprising:
a stream input control section for controlling input of a plurality of different streams into the stream playback control device under packet-unit time division multiplexing transmission;
a buffer memory for temporarily holding a plurality of packets having time information inputted into the stream playback control device, stream identification information being affixed to each of the plurality of packets;
a time counter provided for each of the plurality of streams for counting up in a specific time cycle;
a time correction section provided for each of the plurality of streams for loading time information of a packet having a predetermined reference time after a lapse of a predetermined time from input of the packet having the predetermined reference time; and
a comparison section provided for each of the plurality of streams for comparing a count value of the time counter with time information of each packet held in the buffer memory,
wherein the rate of each of the streams is reproduced by restoring the packet interval of the stream based on the comparison results of each of the comparison sections.

7. The stream playback control device of claim 6, wherein the stream input control section controls arbitration of input among the plurality of streams according to the number of packets of each of the streams stored in the buffer memory.

8. The stream playback control device of claim 6, wherein the arbitration control performed by the stream input control section is counting the number of remaining packets held in the buffer memory for each stream after input of the packet having the predetermined reference time and putting priority on input of a stream for which the counted number of remaining packets is below a predetermined threshold.

9. The stream playback control device of claim 6, wherein the time correction section converts time information Ti affixed to an i-th packet (i is an arbitrary natural number) to time information Ti based on the time information Ti and time information Ti-1 affixed to an (i-1)th packet by calculating an equation:
T′i=T′i-1+(Ti-Ti-1)* α(α<1).

10. The stream playback control device of claim 6, wherein the comparison section compares the count value of the time counter with time information of each packet held in the buffer memory and, if the two values agree, outputs a packet interval reproduction timing signal, and
the stream playback control device comprises a packet multiplex output section for multiplexing packets of the plurality of streams based on the packet interval reproduction timing signal outputted from the comparison section and outputting the multiplexed results.
